(19) United States
(12) Patent Application Publication
(10) Pub. No.: US 2009/0230783 A1
(43) Pub. Date: Sep. 17, 2009

(54) Solar Portable Power Center

(76) Inventors: Lane Austin Weed, Greenville, SC (US); Donald Lee Weed, JR., Greenville, SC (US)

Correspondence Address: Lane Austin Weed, 17 Apopka Ave., Greenville, SC, 29609, US

(21) Appl. No.: 12/401,597

(22) Filed: May 19, 2009

Related U.S. Application Data
(60) Provisional application No. 61/035,344, filed on Mar. 10, 2008.

(51) Int. Cl. H02J 9/00

(52) U.S. Cl. 307/150

(57) ABSTRACT

A portable solar powered unit including a battery with associated electronics and a solar panel in a portable case with shoulder strap which accommodates a variety of accessory charging ports including multiple AC and DC outputs along with compressed air capabilities and jump starting voltage for the 12 Volt powering of motor vehicle engines.

This application emanates from a previously filed provisional application dated Mar. 10, 2008, application number 61/035,044

### FIELD OF THE INVENTION

This invention relates in general to a portable solar powered unit and deals more particularly with a portable solar powered unit having increased functional flexibility and stability, as well as being more portable and capable of a wide variety of electrical outputs.

### BACKGROUND OF THE INVENTION

In recent years, the cost of generating electricity has increased dramatically. In California, the monthly electric bill for many consumers has more than doubled in the past year. Rolling blackouts, a condition in which geographical sections of the community are alternately cut-off from receiving electricity during an electrical shortage crisis, are becoming increasingly commonplace with more predicted for the summer of 2009. As our planet's natural resources are depleted and as population increases, the importance of effectively harnessing alternative methods of generating electricity has increased.

### Solar Energy

Photovoltaic panels (also called solar panels) are well known and are used to generate electricity from sunlight. Sunlight is “free” and so the cost of electricity generated by a photovoltaic panel is extremely low. However, solar energy is not widely used to generate electricity for residences because of the expense associated with installing a solar energy system onto a residence. Typically, photovoltaic panels are currently fixedly attached to the roof of a house and wired directly into the home's electrical system. Some disadvantages include the fact that the roof may not be optimum location on the home owner's property to receive the best, most direct sunlight. Also, once the system is installed, it is permanent. In other words, if the homeowner moves to a new home, he cannot take the solar generating system with him. Also, it is extremely expensive to install a roof mounted solar generating system.

Japanese Pat. No. 2002-305,866, published on Nov. 18, 2002, describes a portable solar energy system in a trunk-style case with an inverter for generating ac electrical power and rechargeable batteries for storing energy with a detachable battery and inverter. Japanese Pat. No. 2003-92,423, published on Mar. 28, 2003, describes a portable solar energy system in a trunk-style case with an inverter for generating ac electrical power and rechargeable batteries for storing energy with a detachable battery and inverter and with an expandable solar array. Japanese Pat. No. 2004-88,043, published on Mar. 18, 2004, describes a power supply with an array of solar cells, a nickel cadmium battery and an inverter for providing ac power to loads.

None of the above inventions and patents, taken either singly or in combination, is seen to describe the instant invention as claimed. Thus, a portable solar energy system solving the aforementioned problems is desired.

### SUMMARY OF THE INVENTION

The current invention is a highly portable, highly versatile solar power center, slightly larger than a briefcase, which can be carried by hand, or the provided shoulder strap. The housing/case is constructed of aluminum, plastic, foam and lightweight fiber board. Power is stored in a 12 VDC sealed gel (or AGM) battery with a rating of 17ah-30ah. Power collection is handled by one (or two) 10 watt high-efficiency solar panels, encased in an aluminum frame. Additional power collection and charging methods are (with included adapters): A 120V AC wall adapter/charger, and a 12 VDC Cigarette Lighter Adapter (for charging the battery from an automobile, boat, etc in the absence of sunlight). External (non-solar) charging is accomplished through a diode-protected charge jack on the right side of the unit. The unit features include a 200 watt DC to AC Inverter with two AC receptacle plugs, A multi-voltage DC power panel with multiple jacks for various voltages at up to 5 amps, which also houses a voltage regulator for the purposes of regulating/controlling power input from the solar panel(s). Also housed in the unit is a 12 VDC cigarette lighter adapter (30 Amp), adapter cables for connection of various portable electronic devices and batteries (for the purposes of powering or charging those devices), a 17-30 ah 12 VDC Battery with positive and negative poles, a 30 Amp fuse for over current protection, an internal jack for connection of jumper cables (included), and atop the unit, an air compressor (capable of producing air pressures up to 250 psi) for the purpose of providing compressed air (through the included hose and schrader valve adapter) to inflate tires, toys, or various other “air inflatable devices”. The DC voltage regulator/distribution panel contains an LED readout to indicate the current available DC voltage of the unit. On the right side panel, is a “key operated master power switch” to turn off all power inside the unit, and a DC voltmeter (with “test” button), to indicate the charge level of the onboard storage device (battery).

### BRIEF DESCRIPTION OF THE DRAWINGS

FIG. 1: Front view of invention laying on a horizontal surface. (18″×13″×6″) (24#)

FIG. 2: Left Side View with unit open

FIG. 3: Right Side View with unit open, jumper cables, and charging cords

FIG. 4: Rear View of unit

FIG. 5: Right-side view of close unit with air compressor hose and adapters

FIG. 6: General Wiring Schematic/Layout

### DESCRIPTION OF THE PREFERRED EMBODIMENT

The current invention, as depicted in FIGS. 1-6, consists of a lightweight aluminum housing (1A) and (1B), which measures 18″×13″×6″, and is hinged at the rear by (4) (two each). The housing has four rubber feet (5) for storage of the unit on end. The housing is made portable by utilization of the hand-carrying handle (2), or attaching of an optional shoulder strap to buckles (22). The housing is held closed with two locking latches (3). Dividing of the interior compartments is accomplished by foam insulated dividers (6). Attached to the face of the housing is a warning label (9) warning against exposure to moisture and risk of electrical shock. Inside the upper portion of the housing (1B) are two ¾×¾″ aluminum “L” brackets (7) and an elastic strap (8) for the purpose of retaining the solar panel(s) (48) in place while the invention is in transport. The housing contains a 12 VDC Gel type or AGM (advanced glass mat) Battery (44), having both a positive pole (49) and a negative pole (50) for the connection of 12 VDC circuitry. Said battery (44) is connected to each of the following:

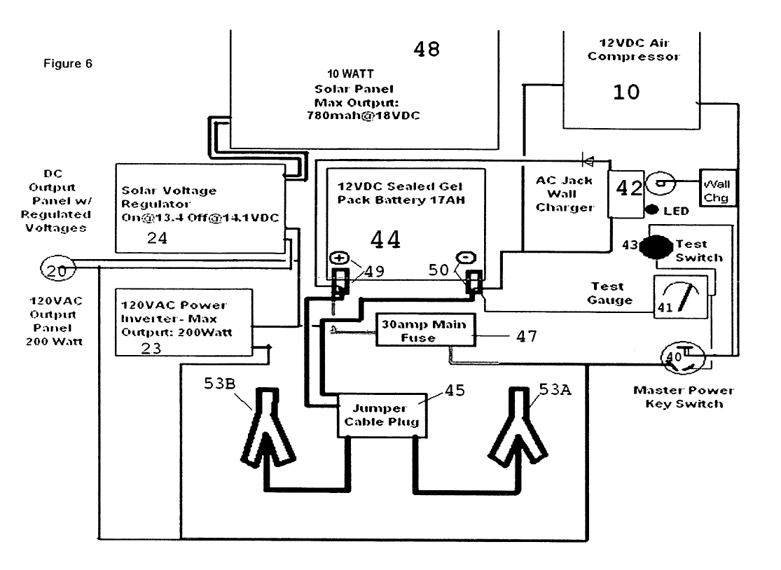

A 30 amp main power fuse (47), and through circuitry depicted in FIG. 6, a MASTER POWER key switch (39,), which can interrupt power input and Output from all devices (except the auxiliary jumper cables (53A & 53B) and an external diode protected charging port (42).

When the Master Key Switch (39) is in the “on” position, the battery (44) is connected to the combination Solar Charge Regulator and DC Distribution Panel (24), which in turn is by various circuitry depicted in FIG. 6, connected to (one or two) solar panel(s) with a rating of 10 watts output each (48) for the purpose of solar powering of Air Compressor (10), DC to AC Inverter (23), DC Output Distribution Panel (24), Jumper Cables (53a & 53b), solar charging of battery (44), or any reasonable combination of the above.

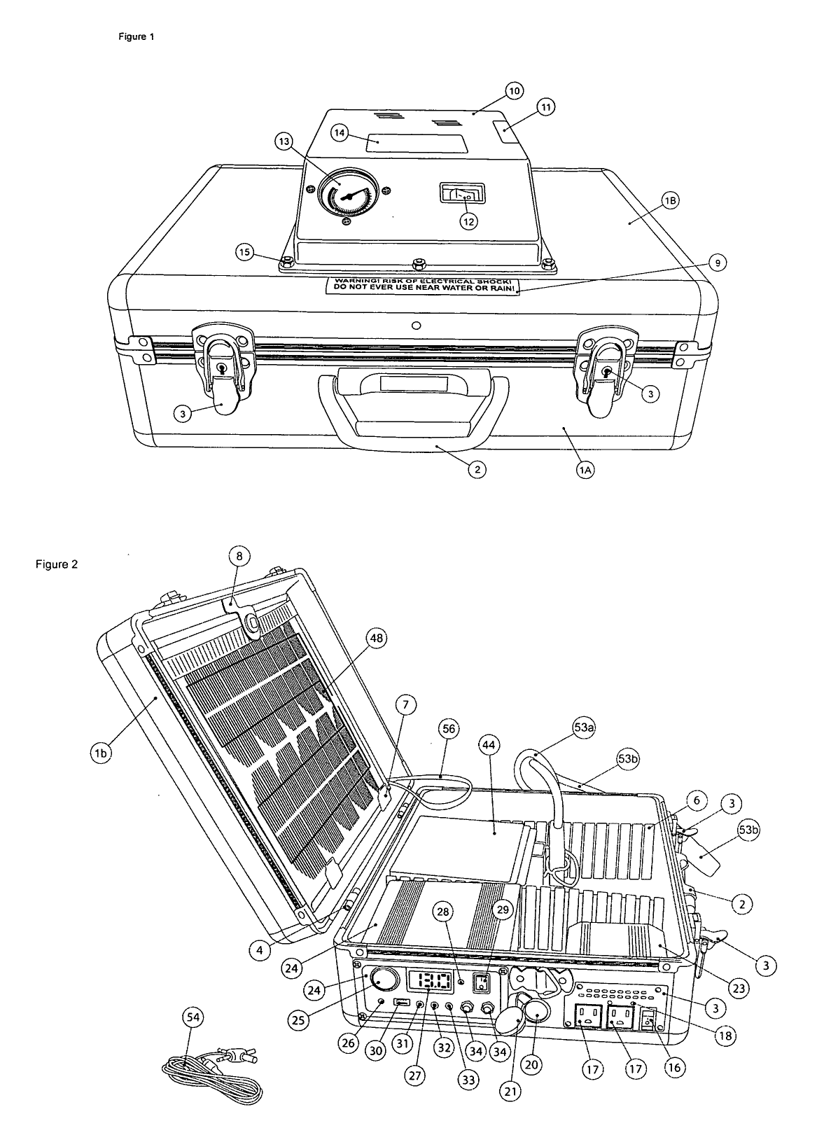

FIG. 2 depicts the left side view of the unit, including the AC to DC Inverter Panel (23), Solar Regulator and DC Distribution Panel (24), and 21.4 mm 12 VDC 30-amp Female Cigarette Lighter Outlet (20) with a rubber cover (21) for powering various higher-amperage 12 VDC accessories such as high-candlepower spotlights (used for example only).

The DC to AC Inverter (23) contains a SPST Rocker Switch, which interrupts power to the Inverter (23). Upon the face of the inverter (23) are two NEMA 5-15-P Female 120 VAC Receptacles (17) capable of producing up to 200 watts of power for the purpose of powering multiple low-amperage 120 VAC portable devices, such as a laptop computer, cell phone charger, portable game charger, a table lamp, etc. The Inverter (23) is equipped with over current protection and/or low DC input voltage warnings (18), and a green “normal operation” LED indicator light (18). The inverter will automatically shut down when AC current exceeds 200 watts continuous output, or when DC input voltage drops below 10.5 VDC.

The Solar Charge Regulator and DC Power Distribution Panel (24) is capable of regulating the charge current of up to 50 watts of solar charge input at various voltages up to 26 VDC. 12 VDC Regulated charge current is returned to the battery (44). The Solar Charge Regulator provides shutdown protection when DC voltage drops below 8VDC, and will illuminate the Low Voltage LED warning lamp (26) at 10 VDC. The DC distribution panel contains a SPST On-Off Rocker Switch (29) for controlling power to the distribution panel. On the face of the panel is a digital LED voltage display panel (27) with a push-button on-off switch (28) for turning off the LED voltage display (27). The face of the DC Power Distribution Panel (24) contains various outlets for simultaneous distribution of various voltage outputs at a total of up to 5 amps. The included outlets/receptacles include: a 5 VDC USB 2.0 Female Receptacle (30) for charging I-Pods and various other battery powered computer peripheral equipment, a 3.5 mm female outlet with 3 VDC output (31), a 3.5 mm female outlet with 6 VDC output (32), a 3.5 mm female outlet with 9 VDC output (33), and two 6.5 mm female outlets with 12 VDC output (34).

The solar panel (48) is attached via a 12″ flexible harness (56), which allows the solar panel (48) to removed from the unit, and placed at an unlimited number of angles (within 12″ of the unit) for solar collection.

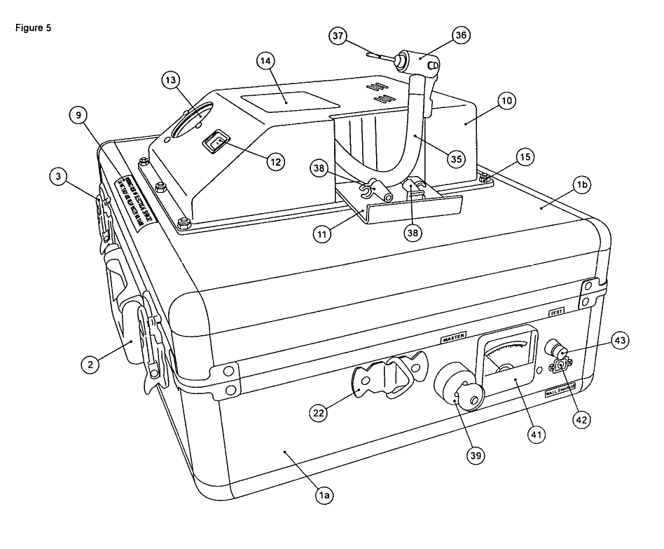

Also depicted in FIGS. 1, 4 & 5, and attached to the top of the main housing (1B) by eight #10×32×¾″ machine screws and nylon locknuts (15) is a plastic air compressor housing (10), which houses a 12 VDC operated air compressor capable of producing up to 250 psi of compressed air through its air hose(35) and adapters (36, 37, 38) located inside the access door (11) Power to the air compressor is controlled by a SPST Rocker Switch (12). A warning label (14) is affixed to the compressor. A 0-300 psi pressure gauge (13) is mounted into the plastic housing (10) and indicates the pressure on the hose (35). The air compressor is capable of inflating tires, balls, water toys, or most inflatable items.

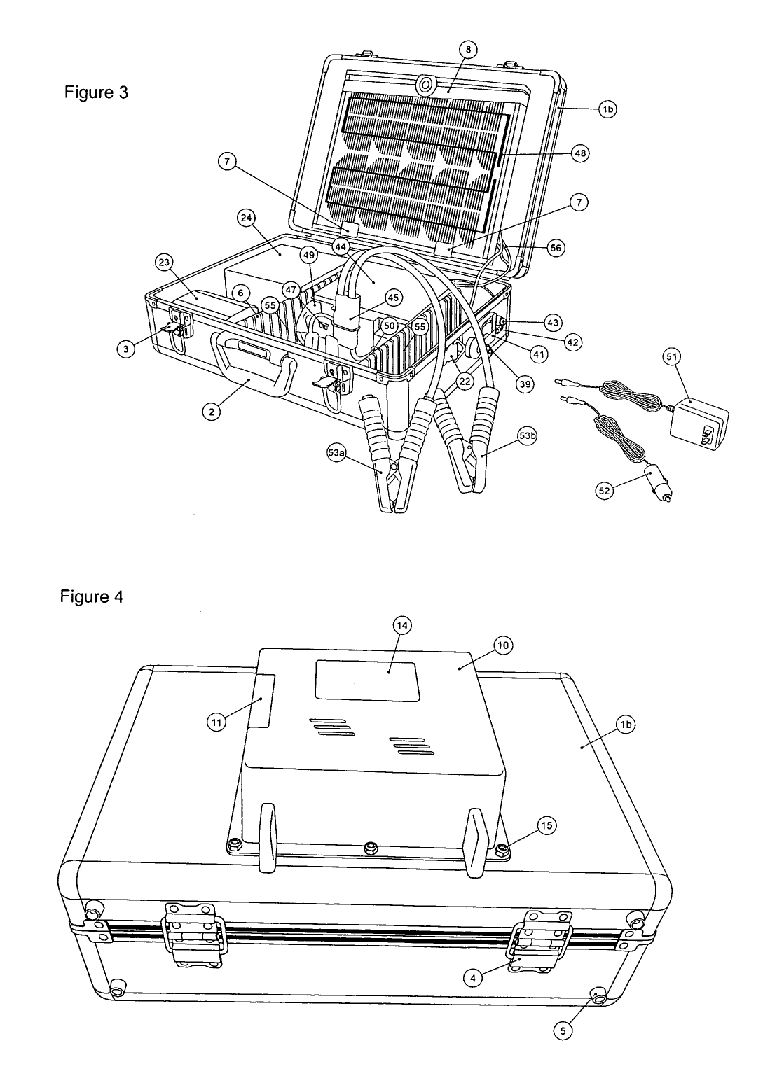

FIGS. 3 & 5 & 6 also depict the Master Key 39 and Master Key Switch (40) which interrupts all power into, or out of the unit (except for 53A & 53B, and alternate diode-protected charging port (42). When the master key (39) and Master Key Switch (40) () are in the “on” position, power is supplied to all circuits of the unit. A DC Voltage Test Button (43) is located on the right side panel for the purpose of monitoring battery charge condition on an analog volt meter (41) while utilizing either the 120 VAC Wall Charge Adapter (51) or the 12 VDC 21.4 mm male cigarette lighter adapter (52) with either being plugged into the diode protected alternate charging port (42).

FIG. 3 depicts the battery (44), the 30 amp main power fuse (47), a shielded jumper cable connector (45) for connecting jumper cables (53A & 53B) and a shielded rubber protector for the jumper cable connector (46). Also depicted are the solar panel(s) (48), positive battery pole (49), and negative battery pole (50).

FIG. 3 also depicts the 50 mah 120 VAC Wall Charger (51), the 12 VDC 21.4 mm Male DC charger (52), and 12 VDC jumper cables (53A Red-Positive & 53B Black-Negative). These jumper cables can jump start many internal combustion engines utilizing a 12 VDC Negative Ground System when plugged into the cable port (45).

FIG. 2 depicts the left side of the unit when open, and the Universal “X” charge cable (54).

FIGS. 2 & 3 depict the portable solar panel (48), which can be removed from the unit, and placed at any angle (facing the sun) for the purposes of collecting solar energy at various unlimited angles. Also depicted are cable storage areas (55) inside the main housing (1A) which are separated by foam protected dividers (6).

1. A solar portable power center comprising:
a. An aluminum housing (1) with rubber feet (5) and carrying handle (2) with foam coated dividers (6), aluminum retaining angle (7) including a short circuiting protector (46) and fuse (47) with portable solar panels (48), wall charger (51), adapter cable (54) and storage areas for additional cables (55)
b. A plurality of AC and DC outputs including an automobile jumper cable connection (45), an air compressor (10) and a cigarette lighter charger (52).

2. A solar portable power center of claim 1 wherein the solar panels are stored within the device until needed.

3. A solar portable power center of claim 1 wherein the power from the solar panels are converted into AC or DC electrical energy.

4. A solar portable power center of claim 1 wherein the solar panels are stored within the device until needed

5. A solar portable power center of claim 1 wherein the rack structure upon which said solar panel sections are mounted is embodied within the aluminum housing lid.

6. A solar portable power center of claim 1 wherein said aluminum housing embodies a 12 VDC Gel type or advanced glass mat battery (44) having both a positive pole (49) and a negative pole (50).

7. A solar portable power center of claim 1 wherein said battery (44) embodies;
a. 30 amp main power fuse (47)
b. a master key power switch (40)
c. an external diode protected charging port (42).

8. A solar portable power center of claim 1 wherein said aluminum housing embodies an AC to DC Inverter Panel (23), Solar Regulator and DC Distribution Panel (24), and 21.4 mm 12 VDC 30 -amp Female Cigarette Lighter Outlet (20) with a rubber protective cover (21).

9. A solar portable power center of claim 1 wherein said aluminum housing embodies a DC to AC Inverter (23) contains a SPST Rocker Switch in line prior to the inverter.

10. A solar portable power center of claim 1 wherein said aluminum housing embodies two NEMA 5-15-P Female 120 VAC Receptacles (17).

11. A solar portable power center of claim 1 wherein said aluminum housing embodies a digital LED voltage display panel (27) with a push-button on-off switch (28).

12. A solar portable power center which embodies a DC Power Distribution Panel (24) which contains 5 amp outlets comprising;
a. a 5 VDC USB 2.0 Female Receptacle (30) for charging I-Pods and various battery powered computer peripheral equipment.
b. a 3.5 mm female outlet with 3 VDC output (31), a 3.5 mm female outlet with 6 VDC output (32), a 3.5 mm female outlet with 9 VDC output (33), and two 6.5 mm female outlets with 12 VDC output (34).

13. A solar portable power center which embodies removable jumper cables stored within the said aluminum housing and an air compressor (10) with a plurality of adapters for inflation of accessories.
